(19) United States
(12) Patent Application Publication
(10) Pub. No.: US 2026/0128941 A1
(43) Pub. Date: May 7, 2026

(54) FALLBACK MECHANISM TO MINIMIZE SERVICE DISRUPTION IN RING TOPOLOGY BASED ON NODE UNAVAILABILITY

(71) Applicant: Cisco Technology, Inc., San Jose, CA (US)

(72) Inventors: Ashok Hegde, Bangalore (IN); Srinivasa Rao Nalluri, Bangalore (IN); Robert Edgar Barton, Richmond (CA); Saravanan M Karunanidhi, Bangalore (IN)

(21) Appl. No.: 18/939,273

(22) Filed: Nov. 6, 2024

(51) Int. Cl. H04L 41/0659

(52) U.S. Cl. CPC H04L 41/0661

(57) ABSTRACT

Disclosed are systems, apparatuses, and methods to minimize service disruption in ring topology based on unavailability of the network device. A network device includes a network interface configured to receive frames from other network devices in a ring network and configured to detect that the network device will become unavailable and, in response to detecting the network device will become unavailable, transmit an unavailability frame to a first network device in the ring network and a second network device in the ring network. The unavailability frame indicates that the network device will become unavailable and causes at least one of the first network device or the second network device to change a transmission direction in the ring network. The unavailability frame is configured and stored in a hardware to reduce the power required to transmit the unavailability frame.

### TECHNICAL FIELD

The disclosure relates generally to Layer 2 networks and, more specifically but not exclusively, to a fallback mechanism to minimize service disruption in ring topology based on node unavailability.

### BACKGROUND

Ring network topologies are commonly utilized in Layer 2 networks, which operate at the Data Link Layer of the OSI model, to ensure reliable data transmission across physical network links. In a ring network, each node is connected in a circular pathway, with data typically traveling in a single direction through the network. Such configurations are particularly advantageous in high-speed network environments, including Fiber Distributed Data Interface (FDDI) networks, industrial automation, utility infrastructures, and broadcasting systems, where consistent and predictable data flow is critical. The dual-attached nodes within a ring network can be configured to transmit data in a single direction, with the option to enable bidirectional communication through the closure of a network switch. In such a topology, when one node within the ring fails, a fallback process can occur that enables a deactivated link to establish a backup path. The fallback process can take time, especially in larger networks with more nodes, and create temporary delays as the network protocols determine the new path for data transmission for each of the nodes. The need to reroute data around the disruption can introduce additional latency and may interrupt sensitive operations in the network.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of a ring network topology.

FIG. 2 is a block diagram illustrating a network device 200 including a fallback mechanism to minimize service disruption in ring topology based on node unavailability in accordance with some aspects of the disclosure.

FIG. 3 is a sequence diagram illustrating a fallback mechanism to minimize service disruption in ring topology based on node unavailability in accordance with some aspects of the disclosure.

FIG. 4 illustrates an example method for minimizing service disruption in ring topology based on node unavailability in accordance with some aspects of the disclosure.

FIG. 5 illustrates a block diagram of a system-on-chip (SoC) used in a network device to perform various functions in hardware in accordance with various aspects of the disclosure.

FIG. 6 shows an example of a computing system, which may be for example any computing device that may implement components of the system.

### DESCRIPTION

### Overview

According to one aspect, a network device is provided to minimize service disruption in ring topology based on unavailability of the network device. A network device includes a network interface configured to receive frames from other network devices in a ring network and configured to detect that the network device will become unavailable and, in response to detecting the network device will become unavailable, transmit an unavailability frame to a first network device in the ring network and a second network device in the ring network. The unavailability frame indicates that the network device will become unavailable and causes at least one of the first network device or the second network device to change a transmission direction in the ring network. The unavailability frame is configured and stored in hardware. The network device does not need to use any extra processing, interrupts, and delays associated with software (e.g., scheduling) and reduces the power required to transmit the unavailability frame. In one aspect, the network device includes a fallback detector configured to detect a loss of a power source. The fallback detector may switch power supply to a backup power source that provides sufficient power to the network device to transmit the unavailability frame. The backup power source (or fallback power source) may include a battery, a capacitor, or capacitors, that store enough power to transmit the unavailability frame and maintain the network device in a powered state until a supervisor node within the ring network reconfigures the network transmission associated with the ring network. In some cases, a switch can be activated that is disabled and prevents collisions, duplicated traffic, and other network challenges with bidirectional paths. The supervisor node may activate the switch and reconfigure network nodes before the network device becomes unavailable. In some cases (e.g., in a replication network), a switch may not be included, and a supervisor node maintains the communication to prevent collisions and other issues.

### Example Embodiments

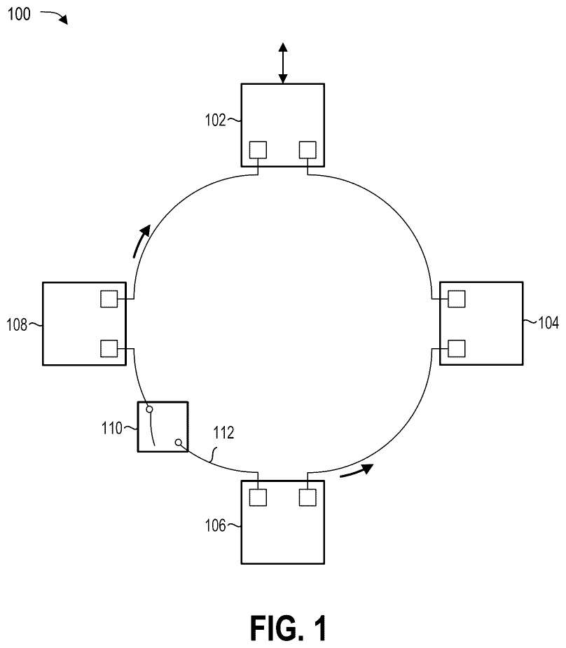

FIG. 1 illustrates an example of a ring network topology 100. A ring network topology 100 forms a circular pathway for data to travel and data passes through each node in one direction until it reaches its destination. Ring networks are common in Layer 2 (e.g., also known as the Data Link Layer in the OSI model) networks to provide reliable transmission of data across a physical network link and have the ability to recover from faults in the network. Layer 2 operates directly above the physical layer and below the network layer and manages data frame delivery between devices on the same network segment. Layer 2 handles tasks such as MAC (Media Access Control) addressing, error detection, and frame sequencing, ensuring that frames are properly directed to their destination on the local network. Common Layer 2 technologies include Ethernet, Wi-Fi, and switches, which operate at this layer to facilitate communication within a local area network (LAN).

For example, ring networks are often used in a fiber distributed data interface (FDDI) network and use a ring topology and are designed for high-speed data transmission over long distances suitable for connecting different locations within a city or metropolitan area. Ring networks are also commonly used in industrial environments, utilities, television broadcasting, campus networks, and other distributed environments.

The ring network topology 100 is configured with dual attached nodes (DANs) at a node 102, a node 104, a node 106, and a node 108, forming a ring. In some cases, the ring network topology 100 may include a switch 110 on a network segment 112. The switch 110 may configure each node to transmit within a single direction in the ring network topology 100. In the event the switch 110 is closed, each of the node 102, the node 104, the node 106, and the node 108 may communicate in two directions. However, the circular path can create frames duplication and collisions and the switch 110 configures the ring network topology 100 so that each of the node 102, the node 104, the node 106, and the node 108 can communication in a single direction around the ring.

In the event that one of the node 102, the node 104, the node 106, or the node 108 becomes unavailable, the ring network topology 100 can recover operations by closing the switch 110 on the network segment 112. In some cases, delays can occur while reconfiguring the ring network topology 100 with the network segment 112 forming based on closing the switch 110 between the node 106 and the node 108, and some of the nodes may need to be reconfigured. Since data travels in a specific direction around the ring network topology 100, any disruption requires the ring network topology 100 to quickly re-establish an alternative route to maintain communication. The reconfiguration of the ring network topology 100 can take time, especially in larger networks with more nodes, and creates temporary delays as the network protocols determine the new path for data transmission for each of the nodes. The need to reroute data around the disruption can introduce additional latency, particularly if the reconfiguration process is complex or if the network relies on older or less efficient protocols. This issue can also persist for other types of networks, such a replication networks (e.g., a Parallel Redundancy Protocol (PRP) network or a High-availability Seamless Redundancy (HSR), etc.), dual ring topology, and so forth and impact the overall performance of the network.

This is a particular problem in Layer 2 networks that use a ring network for high-speed, high-availability networks for critical infrastructure such as utilities (e.g., power generation and distribution), advanced manufacturing (e.g., semiconductor manufacturing) and so forth that require ultra-low packet loss (or frame loss). Layer 2 networks use a frame within the data link layer (Layer 2) and includes the payload data and also headers and trailers that contain control information such as error checking and the physical addresses of the source and destination devices. In contrast, a packet exists at the Network layer (Layer 3) and contains the payload along with a header that includes logical addressing information, such as IP addresses, which facilitates routing the data across different networks. Frames are transmitted of a physical link (e.g., a local area network (LAN) segment) whereas packets are transmitted within the frames. Frames are used for data transmission within local network segments, packets are used to route data between different network segments, enabling communication across larger and interconnected networks.

Systems, apparatuses, processes (also referred to as methods), and computer-readable media (collectively referred to as “systems and techniques”) are described herein for minimizing service disruption in ring topology based on node unavailability. In some cases, a single network device (also referred to as a node) in a ring network can become inactive (e.g., a building may lose power), particularly in a larger distributed network such as a campus network. In one aspect, the system and techniques include a method for detecting that a network device configured in a ring network will become unavailable and transmitting an unavailability frame to a first network device in the ring network and a second network device in the ring network. In this aspect, the unavailability frame indicates that the network device will become unavailable.

In some aspects described below, the unavailability frame is programmed into a hardware component (e.g., in registers) and preconfigured. In this case, the network device may not conserve power without requiring software processing, interrupts, and other events that incur delay. Once the network device determines that it will become unavailable (e.g., by identifying power loss from alternating current (AC)), the network device may send the unavailability frame to other devices within the ring network to reconfigure the ring network before the network device becomes unavailable. For example, a supervisor device in the ring network may enable a switch to create a different route around the ring network for some network devices. The supervisor device may also determine how other network devices send frames and may provide routing information to the other network devices. The unavailability frame may include the address of the network device, which allows the supervisor device to determine the routing of frames within the reconfigured network. The supervisor device reconfigures the network before the network device becomes unavailable, minimizing disruption based on the network device becoming unavailable.

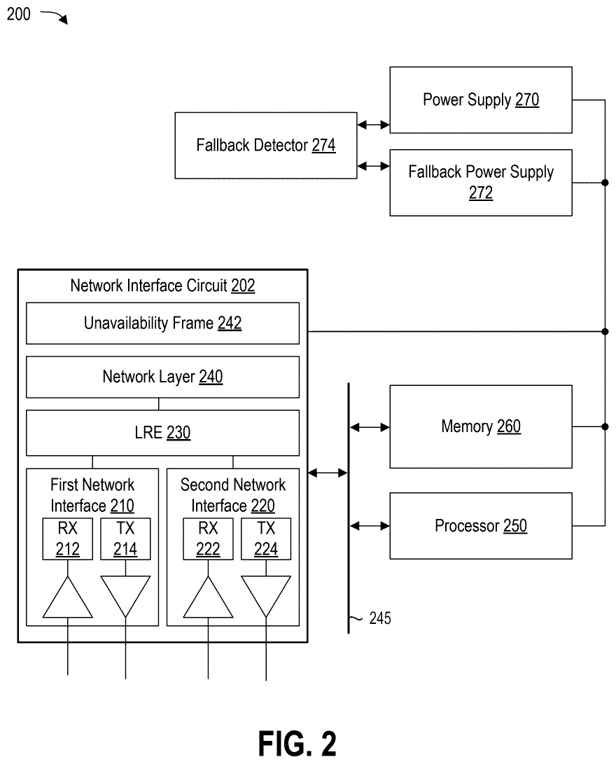

FIG. 2 is a block diagram illustrating a network device 200 including a fallback mechanism to minimize service disruption in ring topology based on node unavailability in accordance with some aspects of the disclosure. The network device 200 includes a network interface circuit 202 that includes a first network interface 210 and a second network interface 220. The network interface circuit 202 also includes a frame circuit 230 for processing frames and a network layer 240 for processing packets. The first network interface 210 is connected to a first network (e.g., the first nodes) and includes a receive circuit 212 and a transmit circuit 214 for providing access to the physical interface. The second network interface 220 is connected to a second network (e.g., the second nodes) and includes a receive circuit 222 and a transmit circuit 224 for providing access to the physical interface. The frame circuit 230 is a hardware component and is configured to receive frames from the first network interface 210 or the second network interface 220 and process the frames in the order received. In some cases, the frame circuit 230 may include a link redundancy entity (LRE) for processing redundant frames (e.g., in a PRP network) and various operations to provide various fallback and frame processing operations (e.g., replication, deduplication, etc.).

The network interface circuit 202 also includes a bus 245 or other system interconnect for communication with other components in the network interface circuit 202. For example, the bus 245 allows the network interface circuit 202 to interface with a processor 250 and a memory 260 for higher layers (e.g., an application layer).

The network device 200 also includes a power supply 270 to provide power (e.g., 12V, 3.3V, etc.) to enable operation of the various components, such as the network interface circuit 202, the processor 250, and the memory 260. The memory 260 can store data pertaining to the operation of a network and includes a node table for managing and tracking the participating devices within a network (e.g., a PRP or an HSR network). In some cases, the memory can also be embedded at the circuit level and accessible via hardware. For example, the node table may manage and monitor the devices within the network, ensuring robust communication and fault tolerance. The node table contains essential information such as unique identifiers (node identifiers), human-readable names (node names), current statuses (node statuses), and interface details for each node for communication (e.g., in the ring network topology 100 of FIG. 1).

In one aspect, the network device 200 can also include a fallback power supply 272 that is configured to provide an amount of power to maintain a network availability in the event that the power supply 270 becomes unavailable (e.g., AC power becomes unavailable). For example, the fallback power supply 272 can be a capacitor (e.g., if a single DC power is required), a plurality of capacitors, a backup power supply, etc. In the event that power is lost at the power supply 270, the fallback power supply 272 can continue to supply voltage for a period of time to reconfigure a network (e.g., the ring network topology 100 in FIG. 1). The network device 200 may also include a fallback detector 274, which can detect a power loss at the power supply 270 or detect a decrease in voltage within the fallback power supply 272. In some cases, the fallback power supply 272 can provide the necessary power for a portion of the devices necessary for processing and forwarding the unavailability frame 242. For example, some circuits of the network device 200 may be powered down because their function is no longer required, such as a bias voltage and other signals necessary for a cooling function (e.g., a fan). In this case, the network device 200 is going offline, and a 12V power supply for the fan may not be necessary and can be disabled. Other aspects can be selectively disabled as well based on the fact that the network device 200 will become unavailable. In this case, the fallback power supply 272 can be designed to proactively maintain the components necessary to switch the network seamlessly before the network device 200 becomes unavailable.

In some aspects, the network device 200 may also include an unavailability frame 242 that is preconfigured and available to hardware components of the network interface circuit 202. The unavailability frame 242 can be a number of registers that store a programmed message in a frame that can be provided to other network devices to trigger a network operation. In other cases, the unavailability frame 242 can be permanently configured in hardware with a frame. In either case, when the fallback detector 274 detects that the power supply falls back to the fallback power supply 272, the network device 200 has lost a power supply and is relying, at least primarily, on the fallback power supply 272 (e.g., the fallback power supply 272 provides the bulk of the power supply) and power loss is imminent. Accordingly, the fallback detector 274 can trigger the network interface circuit 202 to provide the unavailability frame 242 to peer devices. A peer device may receive the unavailability frame 242, process the unavailability frame 242, and reconfigure the network (e.g., the ring network topology 100) before the network device 200 becomes unavailable. In some cases, the peer node may be a direct neighbor of the network device 200, but may be more than a single hop away from the network device 200. When the peer node is more than a hop away, the neighboring peer nodes forward the unavailability frame 242 until received by a node that controls the network.

In this aspect, the network device 200 maintains power at least for the duration needed by the network (e.g., the ring network topology 100 of FIG. 1) to reconfigure a network path to exclude at network segment of the network device 200.

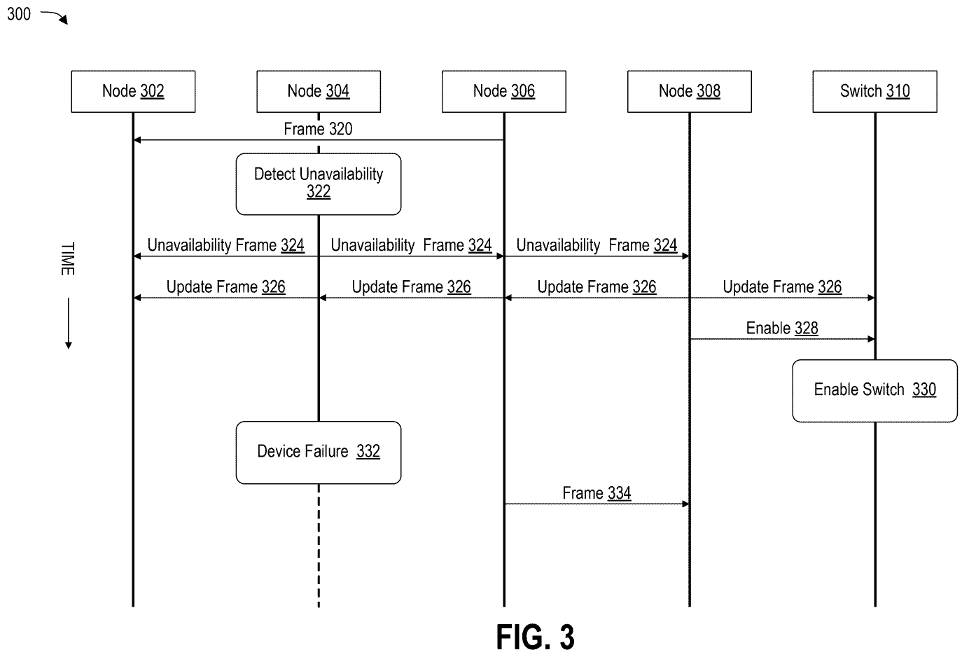

FIG. 3 is a sequence diagram 300 illustrating a fallback mechanism to minimize service disruption in ring topology based on node unavailability in accordance with some aspects of the disclosure. In some aspects, a ring network is configured and includes a first node 302 (e.g., the node 102 in FIG. 1), a second node 304 (e.g., the node 104 in FIG. 1), a third node 306 (e.g., the node 106 in FIG. 1), a fourth node 308 (e.g., the node 108 in FIG. 1), and a switch 310 (e.g., the switch 110 in FIG. 1). In some aspects, the network can include a separate network control function, or one of the first node 302, the second node 304, the third node 306, and, the fourth node 308 may server as a controller of the network. Similar to FIG. 1, the switch 310 is presumed to be located on a network segment between the fourth node 308 and the third node 306, and the third node 306 thereby transmits frames in a counter-clockwise direction and the fourth node 308 transmits data frames in a counter-clockwise direction (e.g., as shown in FIG. 1).

In some aspects, a frame 320 may be transmitted by the third node 306 to the first node 302. For example, the third node 306 may transmit a frame to a destination node, and the first node 302 may serve as an egress route from the network to the destination node. In this case, the frame is transmitted in a counter-clockwise direction as shown in FIG. 1.

At block 322, the second node 304 detects that it will become available and sends an unavailability frame 324 in both directions. For example, the first node 302, the third node 306, and the fourth node 308 receive the unavailability frame 324. In this case, the fourth node 308 is presumed to perform control plane functions of the ring network, and upon reception of the unavailability frame 324, reconfigures the network paths and transmits an update frame 326 to all corresponding nodes to update routing information within the associated hardware, memory, and so forth. In this case, the second node 304 may also receive the block 330 and may elect to not process the frame on account of becoming unavailable. For example, the second node 304 may have shut down reception circuitry. Each of the first node 302, the third node 306, and the fourth node 308 configure their routing information in response to the update frame 326.

The fourth node 308 (or other device) may also provide an enable signal 328 (or another corresponding signal) to the switch 310. In this case, the fourth node 308 is a supervisor node and handles network administration functions, such as by generating an example signal to close the switch 310 and reconfigure the network. For example, the enable signal 328 may be an interrupt that generates a DC voltage, a pulse signal, a frame, or a packet to enable the switch 310. When the enable signal 328 is provided to the switch 310, the second node 304 is presumed to continue being in operation because it has switched to its fallback power source (e.g., the fallback power supply 272). The switch 310 enables and closes its path, forming a connection between the third node 306 and the third node 306 (e.g., corresponding to the network segment 112 between the node 106 and the node 108 in FIG. 1). In this respect, the first node 302, the third node 306, and the fourth node 308 are configured to maintain a network connection when the second node 304 becomes unavailable. For example, at least one segment along the ring network changes direction (e.g., from counter-clockwise to clockwise).

At block 332, which is after the switch 310 switch is enabled and the first node 302, the third node 306, and the fourth node 308 are reconfigured, the second node 304 becomes unavailable. For example, a fallback power supply (e.g., the fallback power supply 272 in FIG. 2) may have drained below a minimum threshold voltage and/or current to maintain circuits necessary to process frames. In some cases, as described above, the second node 304 may preemptively shut down components not necessary for a last gasp period, which is the period between when an external power source (e.g., AC power) become unavailable (e.g., providing no power) and when the hardware components of the second node 304 shut down based on power drain from the fallback power supply (e.g., the fallback power supply 272 in FIG. 2).

In this case, after the second node 304 becomes unavailable, when the third node 306 transmits a frame 334 to the first node 302, the third node 306 transmits the frame in an opposite direction to the fourth node 308 (e.g., clockwise).

In some aspects, the fallback power supply is configured to hold enough power for the second node 304 to provide the unavailability frame 324 to prevent misdelivered frames (or frames for Layer 3 or Layer 7 applications), duplicate routes, collisions, and other phenomenon that can occur when the network is reconfigured after the second node 304 becomes unavailable. In some cases, frames are used for the unavailability message because frames have lower latency and are processed in hardware, not requiring a software interrupt and other aspects for software operation (e.g., a scheduler). Frames reduce the reconfiguration time and safeguard sensitive network operations, ensuring that the network remains operational with minimal disruptions based on the unavailability frame.

In some cases, the unavailability frame 324 is preconfigured in hardware (e.g., programmed into a circuit) or a preconfigured message is stored in a register or hardware accessible memory circuit. The preconfigured message ensures that time between detection of the inevitable shutdown of the network device (e.g., the second node 304) and reconfiguration of the other network devices is minimized.

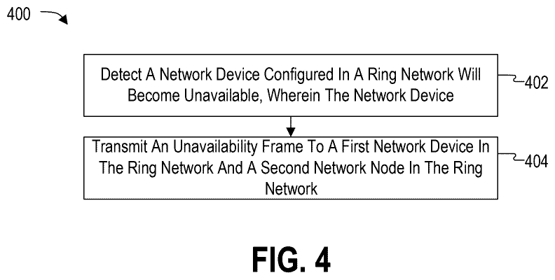

FIG. 4 illustrates an example method for minimizing service disruption in ring topology based on node unavailability in accordance with some aspects of the disclosure. Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence. Although a network device (e.g., using the system-on-chip (SoC) such as SoC 500 or a hardware component such as an FPGA or ASIC, etc.) is described as performing the method, this example is for descriptive purposes.

At block 402, the network device may detect that a network device configured in a ring network will become unavailable. For example, the network device further comprises a fallback detector for detecting a power supply failure and a fallback power supply for providing power during a last gasp period. A last gasp period is at least the duration between detecting power supply failure and a reconfiguration of the other nodes as described above and below. The network device can use other components to detect a loss of a power source and switch the power supply to a backup power source that provides sufficient power to the network device to transmit the unavailability frame

At block 404, the network device may transmit an unavailability frame to a first network device in the ring network and a second network node in the ring network. In some aspects, the unavailability frame indicates that the network device will become unavailable. For example, as a result of detecting the power supply fails and the network device is using the fallback power supply. During the last gasp period, some components may be powered down to conserve power (e.g., a fan).

During the last gasp period, the first network device and the second network device are reconfigured before a fallback power supply of the network device falls below a shutdown threshold of power. In some cases, the first network device and the second network device are configured to detect the unavailability frame in a hardware component and reconfigure network configuration in response to the unavailability frame. The last gasp period safeguards against temporary network disruptions as a result of power failure of a network device. The unavailability frame causes at least one of the first network device or the second network device to change a transmission direction in the ring network.

In some aspects, the unavailability frame is preconfigured and stored in a hardware component. Software interrupt and processing is not necessary, and frames are handled with hardware processing to ensure minimal delay and high data throughput. The unavailability frame includes an identification of the network device and a reason that identifies why the network device is unavailable (e.g., power loss, heap error, stack overflow, network administration, etc.). In some cases, the identification of the network device and the reason are included in a TLV field within a frame. In some aspects, the unavailability frame includes an identification of the network node (e.g., to allow the supervisor device to reconfigure the network to exclude a link associated with the network device becoming unavailable) and the reason. For example, the unavailability frame and include the identification and the reason in one or more type length value (TLV) fields.

In some aspects, the unavailability frame is received by a supervisor node, and the supervisor node, based on the unavailability frame, reactivates a deactivated link in the ring network that excludes the network device in a transmission path.

### Example SoC

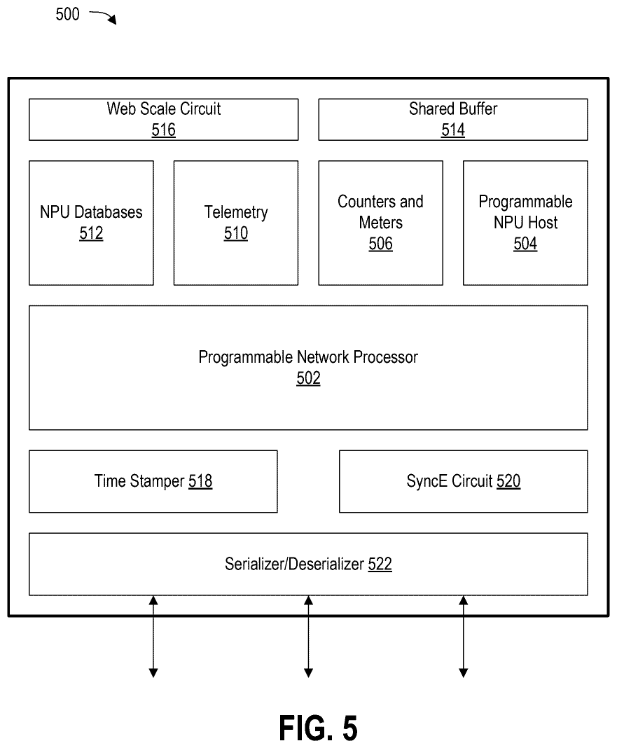

FIG. 5 illustrates a block diagram of an SoC 500 in a network device to perform various functions in hardware in accordance with various aspects of the disclosure. For example, the SoC 500 may include fixed hardware components and programmable hardware components to perform various network tasks. In one illustrative aspect, the SoC 500 includes a programmable network processor 502 (e.g., a network processing unit (NPU), etc.), a programmable NPU host 504, counters and meters 506, telemetry 510, an NPU database 512, a shared buffer 514, a web scale circuit 516, a time stamper 518, a synchronous Ethernet (SyncE) circuit such as SyncE circuit 520, and a serializer/deserializer 522. In some cases, the SoC 500 may be configured to execute bytecode instructions to be supplemented with additional functions. For example, the SoC 500 may be configured to execute various functions described above, and may include hardware support for processing frames and various functions, such as the unavailability frame, in Layer 2.

The programmable network processor 502 may be programmed to perform functions that are conventionally performed by integrated circuits (IC) that are specific to switching, routing line cards, and routing fabric. The programmable network processor 502 may be programmable using the programming protocol-independent packet processors (P4) language, which is a domain-specific programming language for network devices for processing packets. The programmable network processor 502 may have a distributed P4 NPU architecture that may execute at a line rate for small packets with complex processing. The programmable network processor 502 may also include optimized and shared NPU fungible tables. In some aspects, the programmable network processor 502 supports a unified software development kit (SDK) to provide consistent integrations across different network infrastructures and simplifies networking deployments. The SoC 500 may also include embedded processors to offload various processes, such as asynchronous computations.

The programmable network processor 502 includes a programmable NPU host 504 that may be configured to perform various management tasks, such as exception processing and control-plane functionality. In one aspect, the programmable NPU host 504 may be configured to perform high-bandwidth offline packet processing such as, for example, operations, administration, and management (OAM) processing and MAC learning.

The SoC 500 includes counters and meters 506 for traffic policing, coloring, and monitoring. As an example, the counters and meters 506 include programmable counters used for flow statistics and OAM loss measurements. The programmable counters may also be used for port utilization, microburst detection, delay measurements, flow tracking, elephant flow detection, congestion tracking, etc.

The telemetry 510 is configured to provide in-band telemetry information such as per-hop granular data in the forwarding plane. The telemetry 510 may observe changes in flow patterns caused by microbursts, packet transmission delay, latency per node, and new ports in flow paths. The NPU database 512 provides data storage for one or more devices, for example, the programmable network processor 502 and the programmable NPU host 504. The NPU database 512 may include different types of storage, such as key-value pair, block storage, etc.

In some aspects, the SoC 500 includes a shared buffer 514 that may be configured to buffer data, configurations, packets, and other content. The shared buffer 514 may be utilized by various components such as the programmable network processor 502 and the programmable NPU host 504. A web scale circuit 516 may be configured to dynamically allocate resources within the SoC 500 for scale, reliability, consistency, fault tolerance, etc.

In some aspects, the SoC 500 may also include a time of day (ToD) time stamper 518 and a SyncE circuit 520 for distributing a reference to subordinate devices. For example, the time stamper 518 may support IEEE-1588 for ToD functions. In some aspects, the time stamper 518 includes support for a precision timing protocol (PTP) for distributing frequency and/or phase to enable subordinate devices to synchronize with the SoC 500 for nano-second level accuracy.

The serializer/deserializer 522 is configured to serialize and deserialize packets into electrical signals and data. In one aspect, the serializer/deserializer 522 supports sending and receiving data using non-return-to-zero (NRZ) modulation or pulse amplitude modulation 4-level (PAM4) modulation. In one illustrative aspect, the hardware components of the SoC 500 provide features for terabit-level performance based on flexible port configuration, nanosecond-level timing, and programmable features. Non-limiting examples of hardware functions that the SoC 500 may support include IP tunneling, multicast, network address translation (NAT), port address translation (PAT), security and quality of service (QoS) access control lists (ACLs), equal cost multiple path (ECMP), congestion management, distributed denial of service (DDos) migration using control plane policing, telemetry, timing and frequency synchronization, and so forth.

### Example System

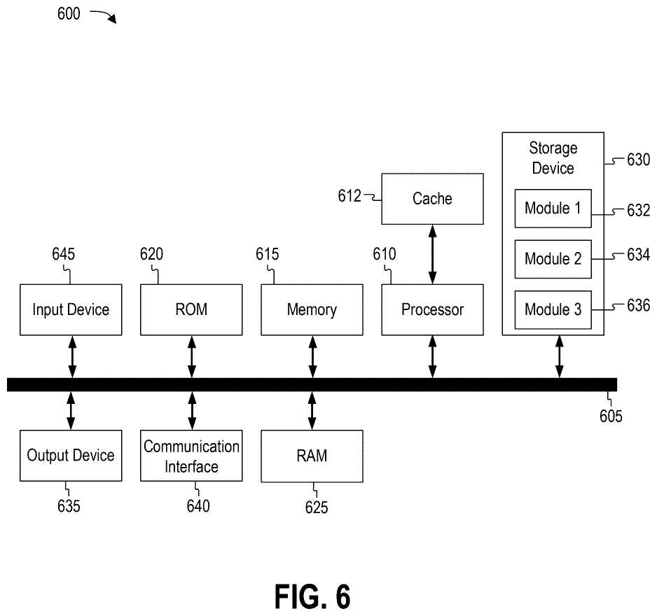

FIG. 6 is a diagram illustrating an example of a system for implementing certain aspects of the present technology. In particular, FIG. 6 illustrates an example of computing system 600, which can be for example any computing device making up internal computing system, a remote computing system, a camera, or any component thereof in which the components of the system are in communication with each other using connection 605. Connection 605 can be a physical connection using a bus, or a direct connection into processor 610, such as in a chipset architecture. Connection 605 can also be a virtual connection, networked connection, or logical connection.

In some aspects, computing system 600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 600 includes at least one processing unit (a central processing unit (CPU) or processor) such as processor 610 and connection 605 that couples various system components including system memory 615, such as ROM 620 and RAM 625 to processor 610. Computing system 600 can include a cache 612 of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some aspects, a hardware service that performs a particular function can include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., method 400, and/or other process described herein) may be performed by a computing device or apparatus. In one example, the method 400 can be performed by a computing device having a computing architecture of the computing system 600 shown in FIG. 6.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphical processing units (GPUs), digital signal processors (DSPs), CPUs, and/or other suitable electronic circuits), and/or can include and/or be implemented using computer software, firmware, or any combination thereof, to perform the various operations described herein.

Aspects of the present disclosure include the following:

In one aspect, a method includes detecting that a network device configured in a ring network will become unavailable; transmitting an unavailability frame to a first network device in the ring network and a second network device in the ring network, wherein the unavailability frame indicates that the network device will become unavailable; and wherein the unavailability frame causes at least one of the first network device or the second network device to change a transmission direction in the ring network.

In another aspect, the unavailability frame is received by a supervisor node, wherein the unavailability frame reactivates a deactivated link in the ring network that excludes the network device in a transmission path.

In another aspect, detecting that the network device configured in the ring network will become unavailable includes detecting a loss of a power source; and switching power supply to a backup power source that provides sufficient power to the network device to transmit the unavailability frame.

In another aspect, the first network device and the second network device are configured to detect the unavailability frame in a hardware component and reconfigure network configuration in response to the unavailability frame.

In another aspect, the unavailability frame is preconfigured and stored in a hardware component.

In another aspect, the unavailability frame includes an identification of the network device and a reason that identifies why the network device is unavailable.

In another aspect, the identification of the network device and the reason are included in a type length value (TLV) field.

In another aspect, the first network device and the second network device are reconfigured before a fallback power supply of the network device falls below a shutdown threshold of power.

In another aspect, the network device further comprises a fallback power supply for providing power during a last gasp period.

In another aspect, the network device further comprises a fallback detector for detecting a power supply failure.

In one aspect, a network device for minimizing service disruption in ring topology based on unavailability of the network device, includes a network interface configured to receive frames from other network devices in a ring network and including a frame processing circuit for processing frames and configured to: detect that the network device will become unavailable; and in response to detecting the network device will become unavailable, transmit an unavailability frame to a first network device in the ring network and a second network device in the ring network, wherein the unavailability frame indicates that the network device will become unavailable and the unavailability frame causes at least one of the first network device or the second network device to change a transmission direction in the ring network.

In another aspect, the unavailability frame is received by a supervisor node, wherein the unavailability frame reactivates a deactivated link in the ring network that excludes the network device in a transmission path.

In another aspect, the network device further includes a fallback detector configured to detect a loss of a power source; and switch power supply to a backup power source that provides sufficient power to the network device to transmit the unavailability frame.

In another aspect, the first network device and the second network device are configured to detect the unavailability frame in a hardware component and reconfigure network configuration in response to the unavailability frame.

In another aspect, the unavailability frame is preconfigured and stored in a network interface.

In another aspect, the unavailability frame includes an identification of the network device and a reason that identifies why the network device is unavailable.

In another aspect, the identification of the network device and the reason are included in a type length value (TLV) field.

In another aspect, the first network device and the second network device are reconfigured before a fallback power supply of the network device falls below a shutdown threshold of power.

In another aspect, the network device further comprises a fallback power supply configured to provide power during a last gasp period.

In another aspect, the network device shuts down at least one extra component of the network device during the last gasp period.

### Variations and Implementations

Aspects described herein may include one or more networks, which can represent a series of points and/or network elements of interconnected communication paths for receiving and/or transmitting information (e.g., packets, frames, etc.) that propagate through the one or more networks. These network elements offer communicative interfaces that facilitate communications between the network elements. A network can include any number of hardware and/or software elements coupled to (and in communication with) each other through a communication medium. Non-limiting examples of a network include local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks propagate signal using any suitable technologiy for communications including wireless communications (e.g., 4G, 5G, IEEE 802.11 (e.g., Wi-Fi®/Wi-Fi 6®/Wi-FI 7®), IEEE 802.16 (e.g., Worldwide Interoperability for Microwave Access (WiMAX)), Radio-Frequency Identification (RFID), Near Field Communication (NFC), Bluetooth™, Ultra-Wideband (UWB), etc.), and/or wired communications (e.g., circuits, T1 lines, T3 lines, digital subscriber lines (DSL), Ethernet, Fibre Channel, etc.). Generally, any suitable means of communications may be used such as electric, acoustic, electromagnetic, light, and/or infrared to communicate through one or more networks in accordance with the disclosed aspects. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an ASIC, FPGAs, or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method, comprising:
detecting that a network device configured in a ring network will become unavailable; and
transmitting an unavailability frame to a first network device in the ring network and a second network device in the ring network,
wherein the unavailability frame indicates that the network device will become unavailable, and
wherein the unavailability frame causes at least one of the first network device or the second network device to change a transmission direction in the ring network.

2. The method of claim 1, wherein the unavailability frame is received by a supervisor node, wherein the unavailability frame reactivates a deactivated link in the ring network that excludes the network device in a transmission path.

3. The method of claim 1, wherein detecting that the network device configured in the ring network will become unavailable comprises:
detecting a loss of a power source; and
switching power supply to a backup power source that provides sufficient power to the network device to transmit the unavailability frame.

4. The method of claim 1, wherein the first network device and the second network device are configured to detect the unavailability frame in a hardware component and reconfigure network configuration in response to the unavailability frame.

5. The method of claim 1, wherein the unavailability frame is preconfigured and stored in a hardware component.

6. The method of claim 1, wherein the unavailability frame includes an identification of the network device and a reason that identifies why the network device is unavailable.

7. The method of claim 6, wherein the identification of the network device and the reason are included in a type length value (TLV) field.

8. The method of claim 1, wherein the first network device and the second network device are reconfigured before a fallback power supply of the network device falls below a shutdown threshold of power.

9. The method of claim 1, wherein the network device further comprises a fallback power supply for providing power during a last gasp period.

10. The method of claim 9, wherein the network device further comprises a fallback detector for detecting a power supply failure.

11. A network device for minimizing service disruption in ring topology based on unavailability of the network device, comprising:
a network interface configured to receive frames from other network devices in a ring network and including a frame processing circuit for processing frames and configured to:
detect that the network device will become unavailable; and
in response to detecting the network device will become unavailable, transmit an unavailability frame to a first network device in the ring network and a second network device in the ring network, wherein the unavailability frame indicates that the network device will become unavailable;
wherein the unavailability frame causes at least one of the first network device or the second network device to change a transmission direction in the ring network.

12. The network device of claim 11, wherein the unavailability frame is received by a supervisor node, wherein the unavailability frame reactivates a deactivated link in the ring network that excludes the network device in a transmission path.

13. The network device of claim 11, further comprising a fallback detector configured to:
detect a loss of a power source; and
switch power supply to a backup power source that provides sufficient power to the network device to transmit the unavailability frame.

14. The network device of claim 11, wherein the first network device and the second network device are configured to detect the unavailability frame in a hardware component and reconfigure network configuration in response to the unavailability frame.

15. The network device of claim 11, wherein the unavailability frame is preconfigured and stored in a network interface.

16. The network device of claim 11, wherein the unavailability frame includes an identification of the network device and a reason that identifies why the network device is unavailable.

17. The network device of claim 16, wherein the identification of the network device and the reason are included in a type length value (TLV) field.

18. The network device of claim 11, wherein the first network device and the second network device are reconfigured before a fallback power supply of the network device falls below a shutdown threshold of power.

19. The network device of claim 11, wherein the network device further comprises a fallback power supply configured to provide power during a last gasp period.

20. The network device of claim 19, wherein the network device shuts down at least one extra component of the network device during the last gasp period.
